(19) United States
(12) Patent Application Publication
(10) Pub. No.: US 2012/0188159 A1
(43) Pub. Date: Jul. 26, 2012

(54) DATA PROCESSING APPARATUS, PICTURE TRANSMISSION SYSTEM AND DATA PROCESSING METHOD

(76) Inventor: Tatsuya Uehara, Akishima-shi (JP)

(21) Appl. No.: 13/333,774

(22) Filed: Dec. 21, 2011

(30) Foreign Application Priority Data
Jan. 21, 2011 (JP) 2011-011353

(51) Int. Cl. G06F 3/033; G06F 3/01

(52) U.S. Cl. 345/157; 345/156

(57) ABSTRACT

According to one embodiment, a data processing apparatus configured to select an application to execute from a plurality of applications, the data processing apparatus includes: a control signal receiver configured to receive an operation instruction for the application and configured to operate the application according to the received instruction; a plurality of image transmitters configured to transmit output of the application to an image output apparatus; a first storage module describing output modules for the plurality of applications, respectively; and a first selection module configured to select the image transmitter according to data related to the activated application stored in the storage module.

### CROSS REFERENCE TO RELATED APPLICATION(S)

The application is based upon and claims the benefit of priority from Japanese Patent Application No. 2011-011353 filed on Jan. 21, 2011, the entire contents of which are incorporated herein by reference.

### BACKGROUND

1. Field

Embodiments described herein relate to a data processing apparatus, a picture transmission system and a data processing method.

2. Description of the Related Art

With latest trends towards larger television screen sizes there are instances where large screens are employed to enjoy PC contents and, by utilizing processing capabilities of PCs, to enable realization of applications that cannot normally be realized on a television alone. In such cases a user sits in front of a television and there is a needs to perform operations to operate the television as described above. Examples of methods for connecting together a television and a PC and operating a PC from the television include the following.

a) Display of everything on the screen of the PC on the television using a display cable such as HDMI. Alternatively, wireless communication can be employed instead of wired communication.

b) A technology like DLNA for transmitting video data held on a PC and reproducing the video data on a TV.

c) Transmitting Graphical User Interface (GUI) data (for example HTML) from a PC to a television and generating a screen on the television side.

While method a) enables display to be executed irrespective of the application, due to transmitting everything on the screen of a PC there are issues such as occasions when the size of displayed characters in not appropriate, and occasions when portions that are not actually required, such as the PC desktop, are transmitted. However, while method b) has the advantage that the entire screen of the television can be used due to only transmitting the required portions, there are still issues in that is can only be used with particular compatible applications. There are also issues with method c) in that it is only usable for particular applications, however due to the screen being generated on the television side there is a high response speed and nimble operation can be achieved.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a perspective view schematically illustrating a computer in an exemplary embodiment;

FIG. 2 is a block diagram illustrating a system configuration of the computer of FIG. 1;

FIG. 3 is a block diagram schematically illustrating a picture display apparatus of the same exemplary embodiment;

FIG. 4 is a functional block configuration diagram illustrating an overall system of the same exemplary embodiment;

FIG. 5 is a diagram illustrating examples of application profiles employed in the same exemplary embodiment;

FIG. 6 is a diagram illustrating an example of an application selection screen of the same exemplary embodiment;

FIG. 7 is a flow chart of an input switching module employed in the same exemplary embodiment;

FIG. 8 is a flow chart of an input-output module selection module employed in the same exemplary embodiment;

FIG. 9 illustrates the external appearance of a mobile device employed in a similar other exemplary embodiment;

FIG. 10 is a block diagram illustrating a configuration of a mobile device employed in a similar other exemplary embodiment; and

FIG. 11 is a functional block configuration diagram illustrating a system overall in a similar other exemplary embodiment.

### DETAILED DESCRIPTION

Explanation follows regarding exemplary embodiments

### First Exemplary Embodiment

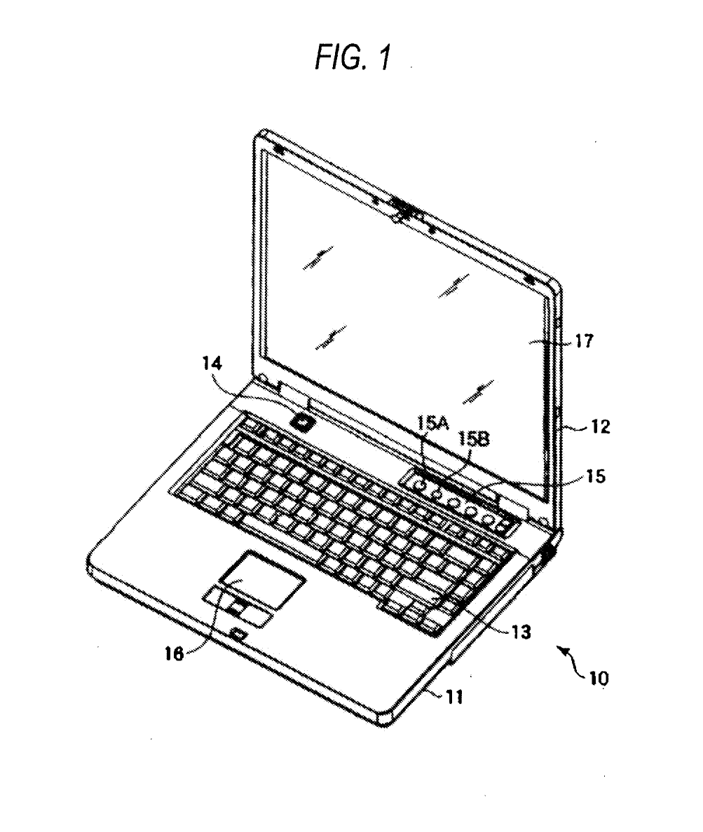

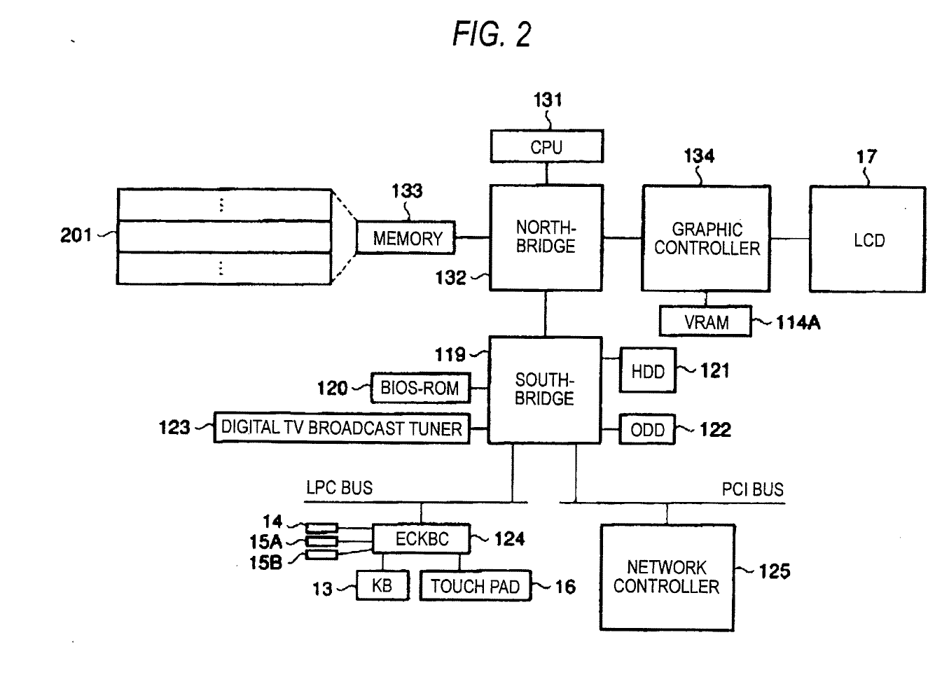

Explanation follows regarding a first exemplary embodiment, with reference to FIG. 1 to FIG. 8. A configuration of a data processing apparatus according to the first exemplary embodiment follows, with reference to FIG. 1 and FIG. 2. The data processing apparatus, for example, may be realized by a notebook personal computer 10. Configuration may also be implemented with a desktop PC.

FIG. 1 is a perspective view of the notebook personal computer 10, as viewed from the front with the display unit in an open state. The computer 10 includes a computer main body 11 and a display unit 12. The display unit 12 is embedded with a display apparatus configured from a Liquid Crystal Display (LCD) 17, with the display screen of the LCD 17 positioned substantially at the center of the display unit 12.

The display unit 12 is attached to the computer main body 11 so as to be able to swing between an open position and a closed position. The computer main body 11 has a thin box-shaped casing, with a keyboard 13, a power button 14 for switching the power of the computer 10 ON or OFF, an input operation panel 15, and a touch pad 16 disposed at on the top face.

The input operation panel 15 is an input device for inputting events corresponding to pressed buttons, and is equipped with plural buttons for activating plural respective functions. A TV activation button 15A and a Digital Versatile Disk (DVD) activation button 15B are included in the button array. The TV activation button 15A is a button for activating a TV function for playing and recording broadcast program data such as a digital TV broadcast program. When pressed by a user the TV activation button 15A automatically activates an application program for executing the TV function. The DVD activation button 15B is a button for playing video contents recorded on a DVD. When pressed by a user the DVD activation button 15B automatically activates an application program for playing video contents.

Explanation follows regarding a system configuration of the computer 10, with reference to FIG. 2.

As shown in FIG. 2, the computer 10 includes a CPU 131, a northbridge 132, a main memory 133, a graphic controller 134, a southbridge 119, a BIOS-ROM 120, a hard disk drive (HDD) 121, an Optical Disk Drive (ODD) 122, a digital TV broadcast tuner 123, an embedded controller/keyboard controller (EC/KBC) IC 124, and a network controller 125.

The CPU 131 is a processor provided for controlling the operation of the computer 10, and loads an Operating System (OS) from the hard disk drive (HDD) 121 into the main memory 133, and executes various application programs such as a video reproduction application program 201.

A not illustrated cache memory in the CPU 131 holds a portion of various programs being executed and related data, enabling processing efficiency to be raised by continuous usage without re-referring to the main memory 133 and without re-writing small changes to contents.

The CPU 131 also executes a system Basic Input Output System (BIOS) stored on the BIOS-ROM 120. The system BIOS is a hardware control program.

The northbridge 132 is a bridging device for connecting between a local bus of the CPU 131 and the southbridge 119. A memory controller for access control of the main memory 133 is also inbuilt to the northbridge 132. The northbridge 132 has functionality for executing communication with the graphic controller 134, such as through an Accelerated Graphics Port (AGP).

The graphic controller 134 is a display controller for controlling the LCD 17 serving as a display monitor of the computer 10. The graphic controller 134 generates a display signal for transmission to the LCD 17 from image data written to a Video Random Access Memory (VRAM) 114A.

The southbridge 119 controls each device on a Low Pin Count (LPC) bus and on a Peripheral Component Interconnect (PCI) bus. The southbridge 119 is inbuilt to an Integrated Drive Electronics (IDE) controller for controlling the southbridge 119, the HDD 121 and the ODD 122. The southbridge 119 has functionality for controlling the digital TV broadcast tuner 123 and for controlling access to the BIOS-ROM 120.

The HDD 121 is a storage device for storing various software and data. The Optical Disk Drive (ODD) 122 is a drive unit for driving a storage medium stored with video contents, such as a DVD. The digital TV broadcast tuner 123 is a reception device for receiving external broadcast program data such as digital TV broadcast programs.

The embedded controller/keyboard controller (EC/KBC) IC 124 is a single chip microcomputer integrated with an embedded controller for power management, and a keyboard controller for controlling the keyboard (KB) 13 and the touch pad 16. The embedded controller/keyboard controller (EC/KBC) IC 124 has functionality for switching power ON or power OFF to the computer 10 in response to operation of the power button 14. The embedded controller/keyboard controller (EC/KBC) IC 124 is also able to switch power ON to the computer 10 in response to operation of the TV activation button 15A and the DVD activation button 15B. The network controller 125 is a communication device for executing communication with an external network, such as the Internet.

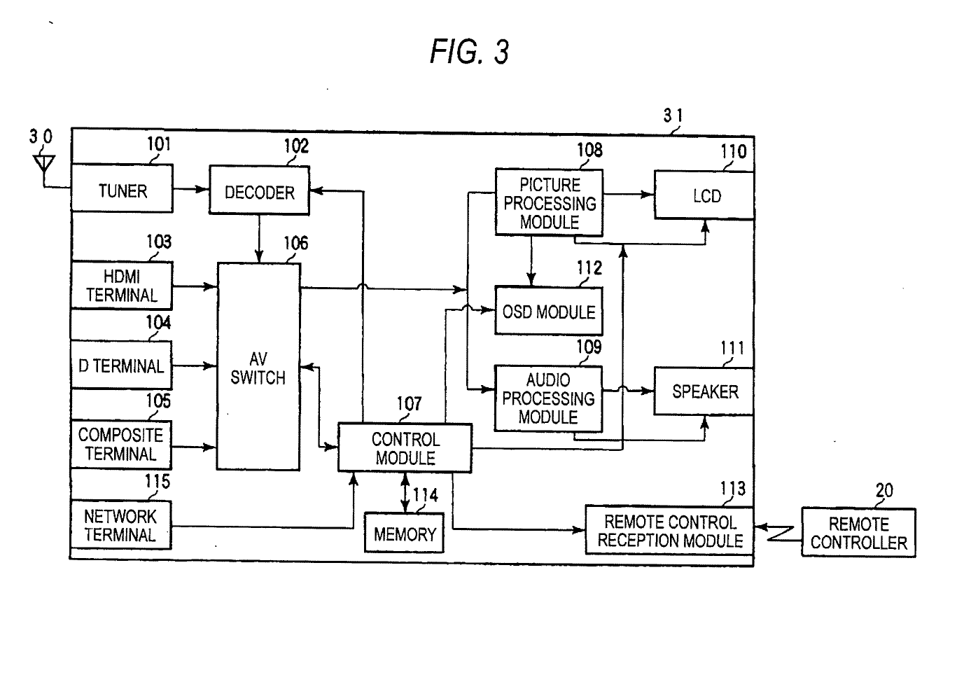

Explanation follows regarding a configuration of a picture display apparatus connected to the image processing apparatus according to the first exemplary embodiment. FIG. 3 is a block diagram showing a configuration of a digital television 31. The digital television 31 includes: a tuner 101, a decoder 102, a High Definition Multimedia Interface (HDMI) terminal 103, a D terminal 104, a composite terminal 105, an AV switch 106, a control module 107, a picture processing module 108, an audio processing module 109, a monitor 110, a speaker 111, an On Screen Display (OSD) module 112, a remote control reception module 113, a memory 114, and a network terminal 115.

The tuner 101 selects and demodulates a signal of a specific frequency from the broadcast signals received by an antenna 30. The decoder 102 performs decoding processing on the signal demodulated by the tuner 101. The HDMI terminal 103 is an external terminal employed for a picture signal transmitted by HDMI connection. The D terminal 104 is an external terminal employed for transmitting a picture signal. The composite terminal 105 is an external terminal employed for transmitting a composite picture signal. The AV switch 106 is input with the signal decoded by the decoder 102 and by signals input through the HDMI terminal 103, the D terminal 104 and the composite terminal 105. The AV switch 106 outputs picture and audio signals from a specific signal, respectively to the picture processing module 108 and the audio processing module 109, according to instruction from the control module 107.

The picture processing module 108 performs picture processing on the picture signal input from the AV switch 106 for display on the monitor 110. The control module 107 performs control of display on the monitor 110 of the picture signal processed by the picture processing module 108.

The audio processing module 109 performs audio processing on the audio signal input from the AV switch 106 for output to the speaker 111. The control module 107 controls output to the speaker 111 of the audio signal processed by the audio processing module 109. The OSD module 112 generates graphic data for display on the screen of the monitor 110 according to instructions from the control module 107. The OSD module 112 outputs graphic data to the picture processing module 108. The OSD module 112 generates as graphic data a menu screen, for example. The remote control reception module 113 receives an infrared signal transmitted from a remote controller 20, and extracts and outputs a remote control signal to the control module 107. The control module 107 controls each module based on the remote control signal received. The memory 114 is stored with various data.

The network terminal 115 transmits and receives UPnP messages and contents data transmitted and received with network connected devices, not shown in the drawings. The network terminal 115 is connected to the control module 107. The control module 107 processes UPnP messages received through the network terminal 115 and transmits UPnP messages through the network terminal 115 to the network. The control module 107 receives contents data from a media server through the network, and outputs the data to the AV switch 106 after, for example, HTTP header processing. The control module 107 temporarily stores contents data in a buffer in the control module 107 and outputs data to the AV switch 106. The control module 107 is employed because sometimes jitter is generated when contents data is received through a network.

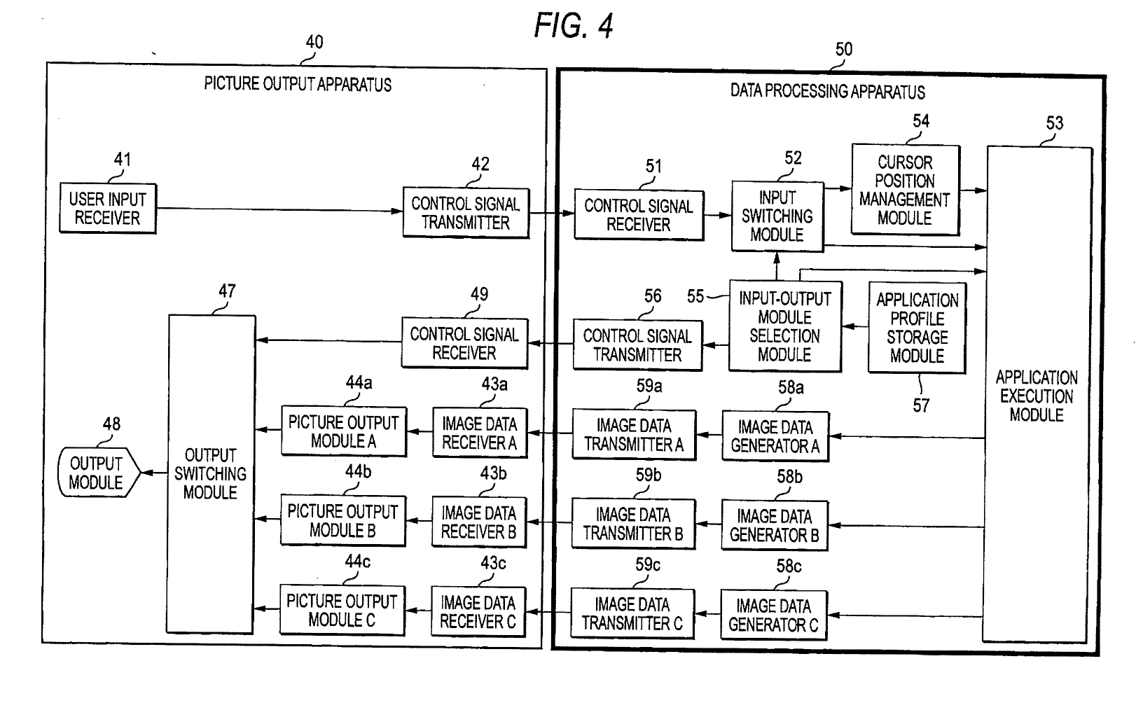

Explanation follows regarding functioning of the first exemplary embodiment, with reference to FIG. 4. A picture output apparatus shown in FIG. 4 is configured by a digital television configured as described above (sometimes referred to below as a TV). A data processing apparatus for application execution is configured by a personal computer of the configuration described above (sometimes referred to below as a PC).

A picture output apparatus 40 has the following modules.

A user input receiver 41: for receiving external user operation instructions, such as from a remote controller.

A control signal transmitter 42: for transmitting operation instructions received from the user input receiver 41 to a data processing apparatus 50.

A image data receiver A 43a: for receiving image data transmitted from the data processing apparatus 50 in a format A.

A picture output module A 44a: for decoding a picture from image data received by the image data receiver A 43a.

A image data receiver B 43b: for receiving image data transmitted from the data processing apparatus 50 in a format B.

A picture output module B 44b: for decoding a picture from image data received by the image data receiver B 43b.

A image data receiver C 43c: for receiving image data transmitted from the data processing apparatus 50 in a format C.

A picture output module C 44c: for decoding a picture from image data received by the image data receiver C 43c.

An output switching module 47: for outputting to an output module 48 the output of one or other of the picture output module A 44a, the picture output module B 44b, or the picture output module C 44c, according to an output instruction by a control signal receiver 49 from a data processing apparatus 50.

The output module 48: for outputting a picture, such as with a LCD TV.

The control signal receiver 49: for receiving output instructions from the data processing apparatus 50 and instructing output switching to the output switching module 47.

The data processing apparatus 50 includes the following modules.

A control signal receiver 51: for receiving operation instructions transmitted from the picture output apparatus 40.

An input switching module 52: for transmitting a control signal transmitted from the control signal receiver 51 to a cursor position management module 54 or to an application execution module 53 as instructed by an input-output module selection module 55.

The application execution module 53: for executing applications.

The cursor position management module 54: for storing the position of a cursor, such as a mouse cursor, in a free-cursor compatible application, and moving the cursor position according to a control signal transmitted from the picture output apparatus through the input switching module 52.

The input-output module selection module 55: for switching input and output of the input switching module 52 and, via a control signal transmitter 56, the picture output apparatus 40, according to input and output characteristics of an application stored in an application profile storage module 57.

The control signal transmitter 56: for transmitting a picture output selection instruction to the picture output apparatus 40.

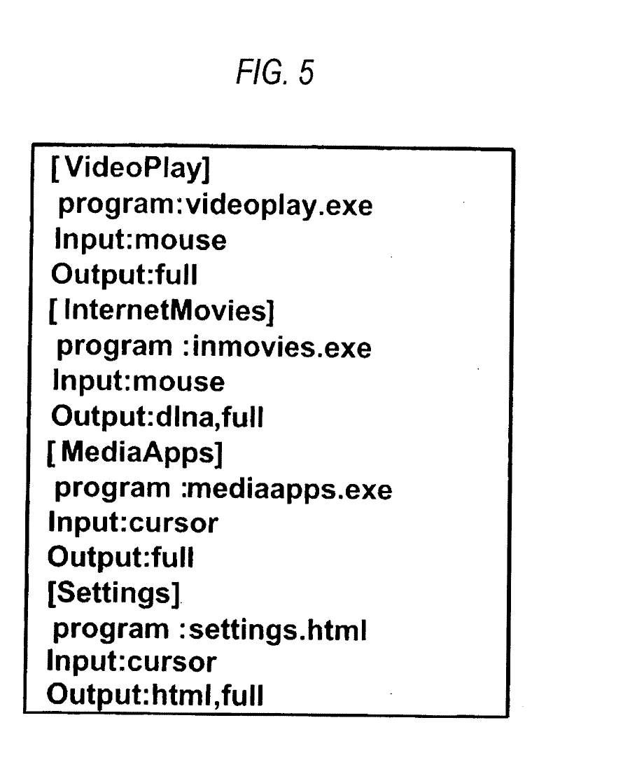

The application profile storage module 57: for describing input and output conditions for each application. The respective formats are described, for example, as shown in FIG. 5. In this example description is by way of text format, however description may be in a binary or database format. In this example all of the applications are described in a single file, however configuration may be made in which description is separately made for each application.

Explanation follows regarding the formats of FIG. 5.

[AAA]: AAA represents a program name.

Program: aaa.exe represents an execution file for a program (and may include a file path).

Input: mouse indicates a mouse mode and cursor indicates a cursor mode for the input mode.

Output: full indicates transmission of the entire screen, dlna indicates DLNA transmission, and html indicates HTML protocol transmission for the output mode.

Note that with respect to input and output, plural execution instructions are possible with comma segmentation, with preferential execution from the top.

An image data generator A 58a: for receiving output data of an application and converting it into image data of format A.

An image data transmitter A 59a: for transmitting image data of format A to the picture output apparatus 40.

An image data generator B 58b: for receiving output data of an application and converting it into image data of format B.

An image data transmitter B 59b: for transmitting image data of format B to the picture output apparatus 40.

An image data generator C 58c: for receiving output data of an application and converting it into image data of format C.

An image data transmitter C 59c: for transmitting image data of format C to the picture output apparatus 40.

The transmission formats A, B, C employed in the present exemplary embodiment are as set out below.

Format A (full screen transmission): a PC HDMI terminal (although not shown in FIG. 3 the terminal externally outputs the contents of the VRAM 114A through the graphic controller 134) is connected to the TV HDMI terminal 103 for displaying the entire PC screen through the HDMI on the TV. When this is performed the image data generating module does not carry out any particular processing, the HDMI transmitter serves as the image data transmitter, the HDMI receiver serves as the image data receiver, the picture output module performs no processing, the image data of the HDMI is output to the screen through the AV switch 106.

Format B (DLNA): the picture processing apparatus transmits a picture to the TV using DLNA. The PC side LAN terminal (on the network controller 125, not shown in FIG. 3) and the TV side LAN terminal 115 are connected together with a network cable. When Format B transmission is performed the image data generating module converts (transcodes) to an image format capable of TV output, and the image data transmitter serves as a Digital Media Server (DMS) and transmits a picture according to a DLNA (Digital Living Network Alliance) standard. The image data receiver receives a picture signal transmitted according to a Digital Media Renderer (DMR) standard, and in the picture output module decoding processing of the picture is performed to match the received picture format (for example MPEG-2).

Format C (HTML): an application outputs in a Hyper Text Markup Language (HTML) format, and uses a Hyper Text Transfer Protocol (HTTP) to transfer and display on the TV side. When Format C transmission is performed, the image data generating module transmits the HTML data of the application without particular processing. The image data transmitter functions as an http server, the image data receiver is connected as an http client to the image data transmitter and acquires the GUI data described in HTML by an http protocol. The acquired GUI data is interpreted and converted back into image data by the picture output module served by an HTML browser.

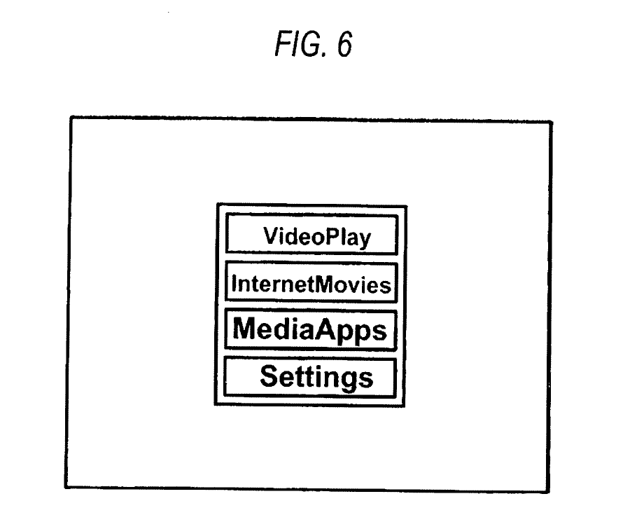

FIG. 6 is a diagram showing an example of an application selection screen of an exemplary embodiment. The four names of applications (VideoPlay, InternetMovies, MediaApps, Settings) correspond to the descriptions shown in FIG. 5. Configuration is made such that, for example, an application can be selected by dialogue using the arrow keys and enter button on the remote controller 20.

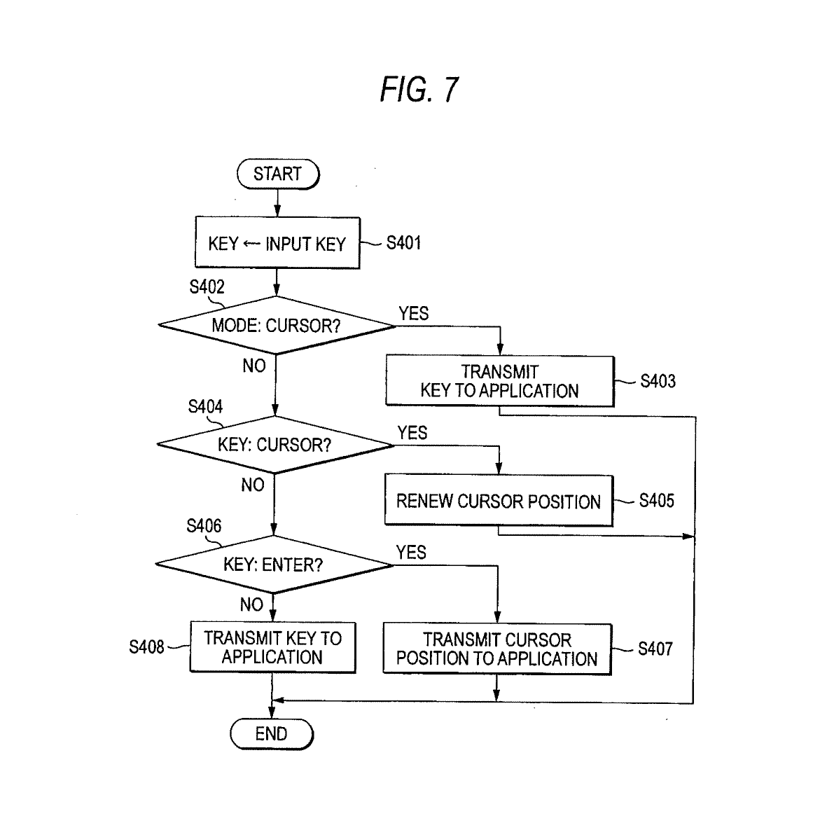

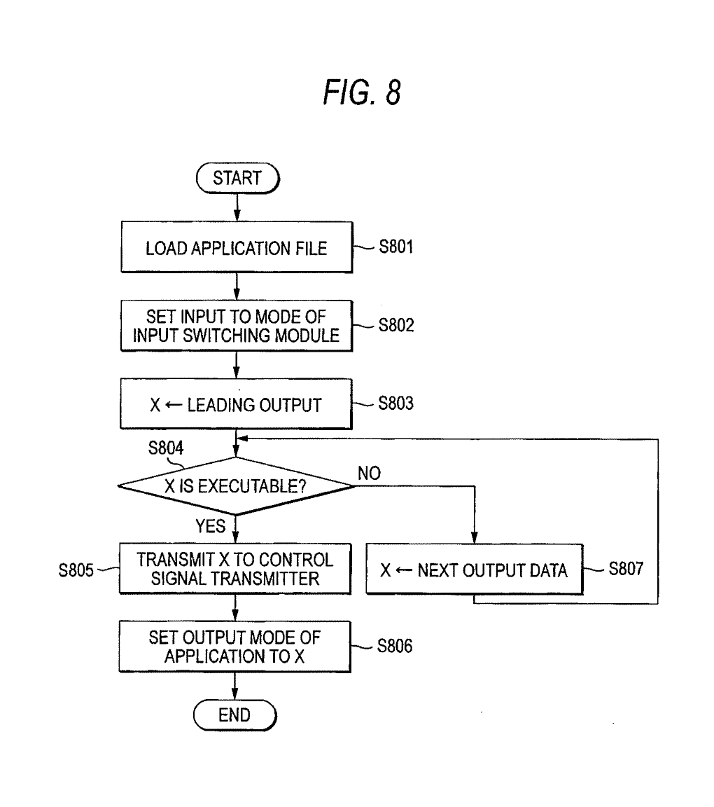

Explanation follows regarding a flow chart of FIG. 7 of the input switching module 52. The processing of FIG. 7, together with that of FIG. 8, is control performed in the main by the CPU 131. The control signal receiver 51 is configured with the network controller 125 interposed between the control signal receiver 51 and the network.

The following operations are performed when control data (key strokes) are transmitted from the control signal receiver 51. The key stroke received is substituted with a number key at step S401. When the current input mode is the cursor mode (step S401: Y) then the key code is transmitted without further processing to the application execution module at step S403. When the mode is not cursor (namely is mouse) (step S402: N), then determination is made as to whether or not the value of the key is one representing a cursor (step S404).

When a cursor key (step S404: Y), the value is transmitted to the cursor position management module 54 and the position of the cursor is renewed (step S405). For example, when the input key is the right cursor then the x coordinate of the cursor position is incremented by 10.

When the input key is not a cursor key (step S404: N), then determination is made as to whether or not it is the enter key. When it is the enter key (step S406: Y) then at step S407 the cursor position management module 54 transmits the current cursor position to the application execution module 53.

When not the enter key (step S406: N) then the key code is transmitted as it is to the application execution module 53 (step S408).

Explanation follows regarding a flow chart of FIG. 8 illustrating processing by the input-output module selection module 55.

The following operations are performed when transmitting the control data (key strokes) from the control signal receiver 51. The application profile is loaded at step S801. Input is then set to the input switching module 52 mode (step S802).

The leading character of the output is substituted into variable X at step S803. Determination is then made as to whether or not the variable X is enabled (step S804).

When the variable X is enabled (step S804: Y), then the value of the variable X is transmitted to the control signal transmitter 56 (step S805). Then, the output mode of the application is set to X (step S806).

When the variable X is not enabled (step S804: N) then at step S807 the subsequent data output is substituted in the variable X.

### Second Exemplary Embodiment

Explanation follows regarding a second exemplary embodiment, with reference to FIG. 3 to FIG. 10. In the second exemplary embodiment a mobile phone is employed in place of the PC of the first exemplary embodiment. Further explanation of common portions in the second exemplary embodiment to those of the first exemplary embodiment is omitted.

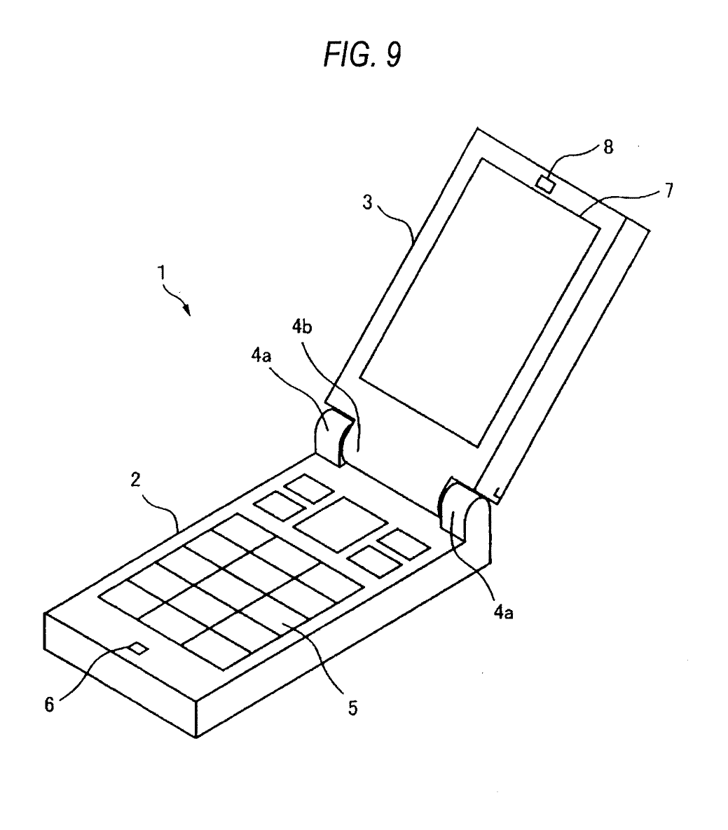

FIG. 9 illustrates the external appearance of a mobile phone 1 employed in the second exemplary embodiment. FIG. 9 illustrates the mobile phone 1 in an open state. The mobile phone 1 includes a first casing 2 disposed with operation keys 5 and a second casing 3 containing a main display screen 7. The first casing 2 and the second casing 3 are connected together by hinges 4a, 4b such that the second casing 3 can swing within a specific range with respect to the first casing 2. A microphone 6, functioning as a speech receiver is provided in the first casing 2. The second casing 3 is provided with a speaker 8 functioning as a speech emitter.

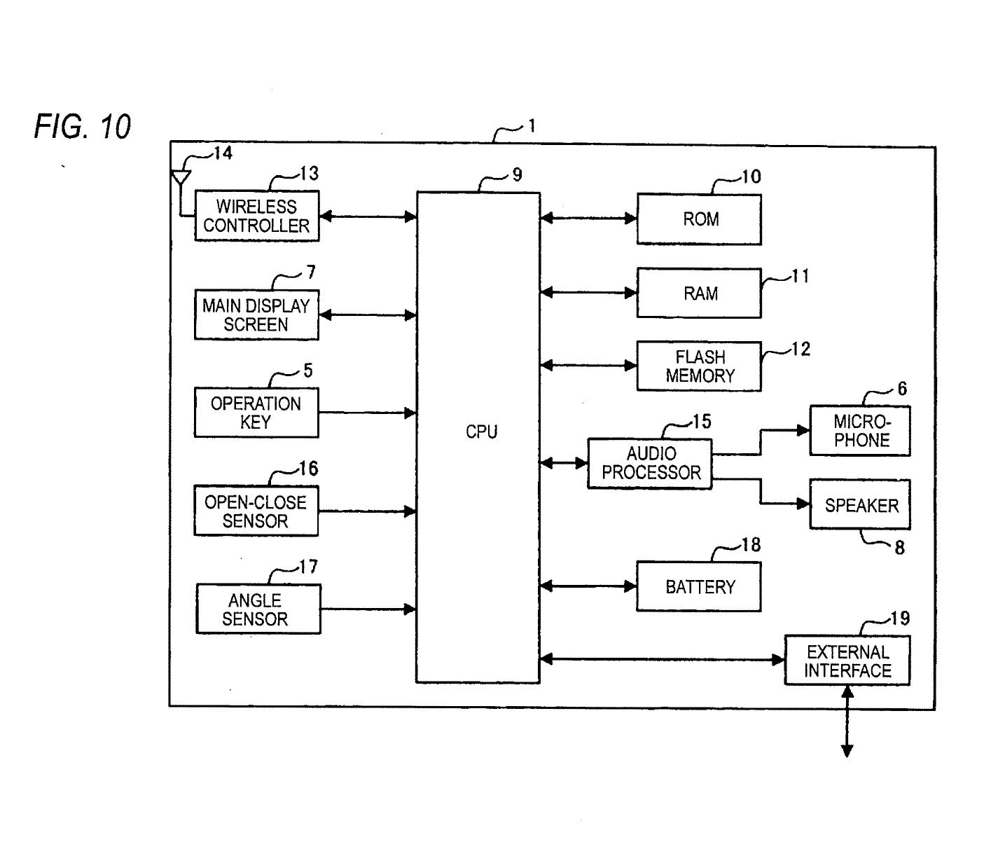

FIG. 10 is a block diagram showing a configuration of a mobile phone 1. The Central Processing Unit (CPU) 9 controls operation of the device as a whole. A Read Only Memory (ROM) 10 stores an operation program and data for the CPU 9, a Random Access Memory (RAM) 11 is utilized as a work area for data processing, such as in CPU 9 operation. The RAM 11 is also employed for temporarily storing picture and audio signals, for example. A flash memory 12 is a re-writable non-volatile semiconductor memory for storing data, such as telephone number data of a telephone book, so as not to be erased when power is switched off. Data of these memories is exchanged with the CPU 9 through a memory interface.

A wireless controller 13 transmits a wireless signal through an antenna 14, and performs wireless communication with another mobile phone through a not illustrated terrestrial base station. An audio processing module 15 converts the received signal into sound for output from the speaker 8. The microphone 6 codes the input sound and transmits the coded sound through the wireless controller 13 and out from the antenna 14. The wireless controller 13 is connected to the CPU 9. The microphone 6 is disposed in the first casing 2 and the speaker 8 is disposed in the second casing 3.

The main display screen 7 includes a Liquid Crystal Display (LCD) and a backlight. The main display screen 7 is disposed in the second casing 3. The operation keys 5 are a group of plural keys for user operation to enter a telephone number or specific signal.

An open-close sensor 16 is a sensor for detecting the open or closed state of the first casing 2 and the second casing 3. Detection can be achieved, for example, by utilizing a combination of a magnetic resistance sensor or Hall sensor with a magnet. The CPU 9 has functionality of open-close detection module that receives a signal of the open-close sensor 16 and detects the open or closed state of the first casing and the second casing.

An angle sensor 17 is a sensor that detects the open angle about the hinge 4 between the first casing 2 and the second casing 3. An angle detector of a combination of a magnetic resistance sensor or Hall sensor and a magnet, or a detection sensor such as a potentiometer or a rotary encoder may be employed as the angle sensor 17. The CPU 9 has functionality for receiving the signal from the angle sensor 17 and detecting the open angle about the hinge of the first casing and the second casing.

A battery 18 is a rechargeable internal battery for supplying power to each module. An external interface 19 is an interface to external devices, and picture signals and control signals are transmitted externally from the CPU 9 through the external interface 19. The CPU 9 externally transmits image data that has been selected by a user from the image data stored in the RAM 11 and the image data stored in the flash memory 12.

There is, for example, a usage mode when the mobile phone 1 is employed as the data processing apparatus to transmit the entire screen of the main display screen 7. There is also a usage mode for transmitting a video or data acquired from the Internet. The operation keys 5 may be configured such that an application can be selected from the four named applications in the application selection screen shown in FIG. 6 by dialogue using the keys and the enter button.

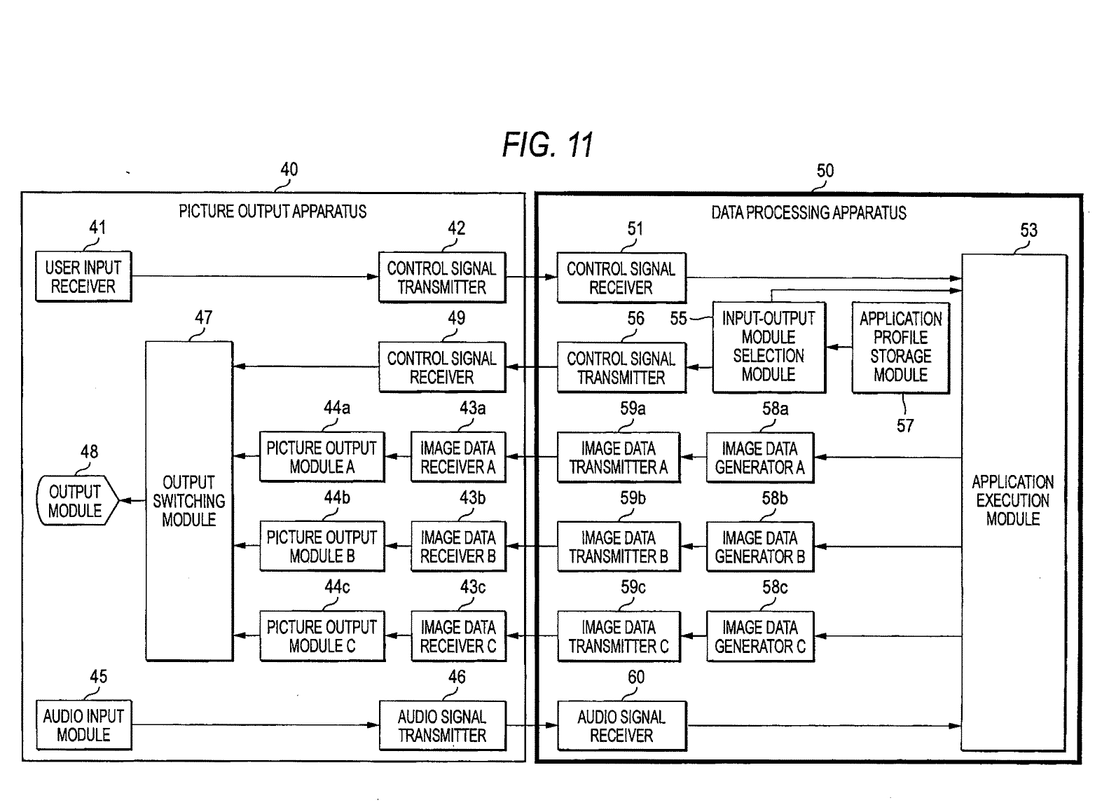

Explanation follows regarding functionality of the second exemplary embodiment, with reference to FIG. 11. Only configuration points that differ to that of first exemplary embodiment shown in FIG. 4 will be explained. The picture output apparatus of FIG. 11 is configured as a digital television similar to that of the first exemplary embodiment. The second exemplary embodiment includes an additional microphone module to the digital television including an audio input module 45 where an analogue signal input from the microphone module is converted into a digital signal and an audio signal transmitter 46 where the obtained digital signal is transmitted to the data processing apparatus through a network.

A data processing apparatus 50 of FIG. 11 is configured based on a mobile device as described above. An audio signal receiver 60 is added to the data processing apparatus of the first exemplary embodiment, for receiving and decoding the audio signal transmitted from the audio signal transmitter 46 of the picture output apparatus, and for outputting to an application execution module so as to input audio for use in an application. This hence enables, for example, application execution through a microphone connected to a television by phoning up.

However, in a mobile device such as a mobile phone, application operation is possible by key input operation alone, and similarly application operation is possible by transmitting key strokes of a remote controller for a picture output apparatus (TV) to a mobile device. The present application is made in consideration of these circumstances and removes the need for the input switching module 52 and the cursor position management module 54, and removes the need for the processing of the input switching module 52 shown in the flow chart of FIG. 7.

The functionality of FIG. 11 is controlled by the CPU 9 of FIG. 9, and configuration may be made with respect to the control signal receiver 51, the control signal transmitter 56, the picture signal transmitting module 59 and the audio signal receiver 60 such that communication is performed with the picture output apparatus 40 through a public network by utilizing the wireless controller 13 of FIG. 9. Alternatively, configuration may be made such that communication is performed with dedicated communication module separate from a public network using wireless technology, such as wireless fidelity (Wi-Fi) by utilizing the external interface 19.

An effect of the exemplary embodiment is that appropriate GUI can be provided to a user TV clue to appropriate connection module selection, by switching between plural connection module according to the application activated on the PC side.

Furthermore, due to being able to automatically switch between free-cursor and mouse-cursor modes according to application, the effort required of a user to switch modes can be reduced.

There is no limitation to the above exemplary embodiments, and various modifications may be implemented within a scope that does not depart from the spirit.

Various configurations can be configured by appropriate combinations of plural configuration elements described in the above exemplary embodiments. For example, a number of configuration elements may be omitted from out of the total configuration elements illustrated in the exemplary embodiments. Appropriate combinations of configuration elements from different exemplary embodiments may also be made. For example, while in the second exemplary embodiment an audio signal is transmitted by the microphone connected to the television, a picture signal may be transmitted together with an audio signal when a camera is additionally installed to the television. Accordingly a video phone function is enabled utilizing a mobile phone.

What is claimed is:

1. A data processing apparatus configured to select an application to execute from a plurality of applications, the data processing apparatus comprising:
a control signal receiver configured to receive an operation instruction for the application and configured to operate the application according to the received instruction;
a plurality of image transmitters configured to transmit output of the application to an image output apparatus;
a first storage module describing output modules for the plurality of applications, respectively; and
a first selection module configured to select the image transmitter according to data related to the activated application stored in the storage module.

2. The data processing apparatus of claim 1, wherein:
the first storage module describes input modules for the applications, respectively; and
the data processing apparatus further comprises:
a cursor position management module configured to control the cursor in the application, and
an second selection module configured to transmit input control data to the cursor position management module or to the application according to the data related to the activated application stored in the first storage module.

3. A picture transmission system configured with a data processing apparatus, the picture transmission system comprising:
a user input receiver configured to receive external user control data;
a control signal transmitter configured to transmit the input to the data processing apparatus;
a plurality of picture receivers corresponding to image transmitter of the data processing apparatus;
a picture output module configure to decode data received by the respective picture receivers; and
a picture output apparatus configured to select an appropriate picture output from a plurality of picture outputs and configured to display the picture output on a screen.

4. A data processing method for a data processing apparatus configured to select an application to execute from a plurality of applications, the data processing method comprising:
prescribing optimum output modules for the plurality of applications, respectively;
receiving an operation instruction for the application and operating the application according to the received instruction;
selecting image transmitter according to the prescribed data for the activated application; and
transmitting the output of the application to the image output apparatus.
